(19) United States
(12) Patent Application Publication
(10) Pub. No.: US 2026/0040283 A1
(43) Pub. Date: Feb. 5, 2026

(54) RESOURCE ALLOCATION AND/OR DETERMINATION ASSOCIATED WITH XR

(71) Applicant: InterDigital Patent Holdings, Inc., Wilmington, DE (US)

(72) Inventors: Ognen Ognenoski, London (GB); Ghyslain Pelletier, Montreal (CA); Jaya Rao, Montreal (CA); Tejaswinee Lutchoomun, Montreal (CA); Francois Periard, Montreal (CA); Paul Marinier, Brossard (CA); Senay Negusse, Montreal (CA); Ahmed Mostafa, Ottawa (CA)

(73) Assignee: InterDigital Patent Holdings, Inc., Wilmington, DE (US)

(21) Appl. No.: 18/792,874

(22) Filed: Aug. 2, 2024

(51) Int. Cl. H04W 72/0446

(52) U.S. Cl. CPC H04W 72/0446

(57) ABSTRACT

Systems, methods, devices, and instrumentalities are described herein related to NR-XR resource allocation. A device (e.g., a wireless transmit/receive unit (WTRU)) may receive configuration information. The configuration information may indicate a logical channel prioritization (LCP) mapping indication. The LCP mapping indication may include one or more of a time-based condition or a priority-based condition. The WTRU may receive an indication of a data flow. The data flow may be mapped to a first logical channel. A protocol data unit (PDU) may be associated with the data flow. The WTRU may determine a transmission resource to use for transmission of the PDU. The determination of the transmission resource may be based on a condition being satisfied. The determined transmission resource may be associated with a second logical channel. A WTRU may transmit the PDU via the determined transmission resource that is associated with the second logical channel.

### BACKGROUND

Mobile communications using wireless communication continue to evolve. A fifth generation may be referred to as 5G. A previous (legacy) generation of mobile communication for example, may be fourth generation (4G) long term evolution (LTE).

### SUMMARY

Systems, methods, devices, and instrumentalities are described herein related to XR (e.g., NR-XR) resource allocation.

A device (e.g., a wireless transmit/receive unit (WTRU) may include a receiver, a processor, and/or a transmitter. The device may be configured to perform one or more actions. The WTRU may be configured to receive configuration information. The configuration information may indicate a logical channel prioritization (LCP) mapping indication (e.g., a dynamic LCP mapping indication (e.g., LCP restriction)). The LCP mapping indication may include one or more of a time-based condition or a priority-based condition. The WTRU may receive an indication of a data flow. The data flow may be mapped to a first logical channel. A protocol data unit (PDU) may be associated with the data flow. The WTRU may determine a transmission resource to use for transmission of the PDU. The determination of the transmission resource may be based on a condition, of the one or more conditions indicated in the configuration information, being satisfied. The determined transmission resource may be associated with a second logical channel. A WTRU may transmit the PDU via the determined transmission resource that is associated with the second logical channel.

The WTRU may determine that the condition is satisfied based on a transmission occasion associated with the first logical channel and a transmission occasion associated with the second logical channel. The determination that the condition is satisfied may be further based on characteristic(s) associated with one or more PDUs (e.g., where the one or more PDUs include the PDU). The determined transmission resource may be associated with the transmission occasion associated with the second logical channel. The satisfied condition may be the time-based condition. The time-based condition may include at least one of: a time remaining for transmission of the PDU satisfies a threshold within a delay budget, a time that the PDU has been in a buffer satisfies a threshold, or a transmission delay associated with transmission of the PDU is within the delay budget.

The satisfied condition may be the priority-based condition. The priority-based condition may include at least one of: a priority, a relative priority, a change in priority associated with the PDU satisfies a first threshold, a PDU set importance (PSI), a relative PSI, or a change in PSI associated with the PDU satisfies a second threshold.

The WTRU may receive an indication of a plurality of transmission resources. The plurality of transmission resources may include the transmission resource. The WTRU may determine a resource usage indication. The resource usage indication may indicate one or more used or unused transmission occasions associated with the plurality of transmission resources. The WTRU may determine a resource usage indication resource. The WTRU may transmit the resource usage indication on the resource usage indication resource.

The WTRU may receive an indication of a default mapping that indicates a mapping limit. The mapping limit may limit mapping of the data flow to the first logical channel.

In some examples, the mapping limit may be suspended based on the determination that the transmission resource that is associated with the second logical channel satisfies the condition.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a diagram illustrating an example of service flows from a WTRU to an application server and/or one or more traffic patterns.

FIG. 3 is a diagram illustrating an example of CG configurations including one or more distribution of transmission occasions.

FIG. 4 is a diagram illustrating an example of data flows to logical channels and/or to transmission occasions.

### DETAILED DESCRIPTION

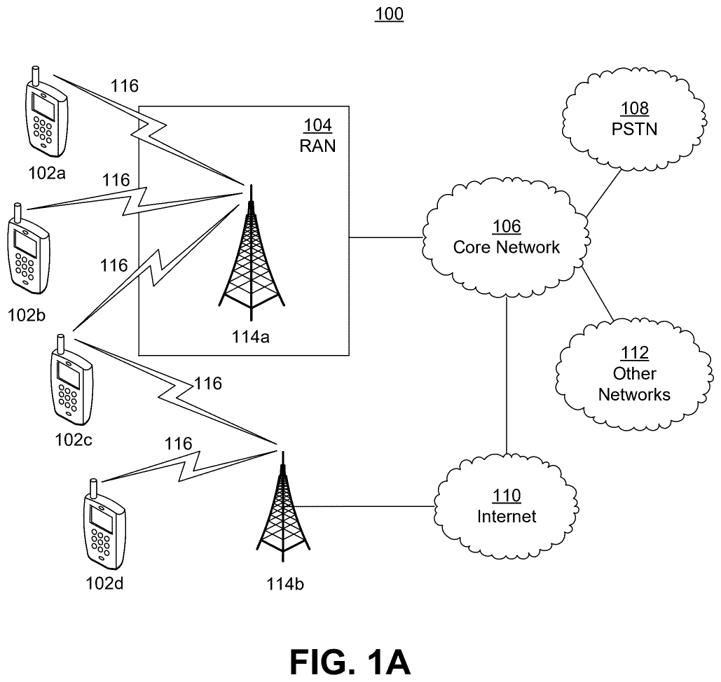

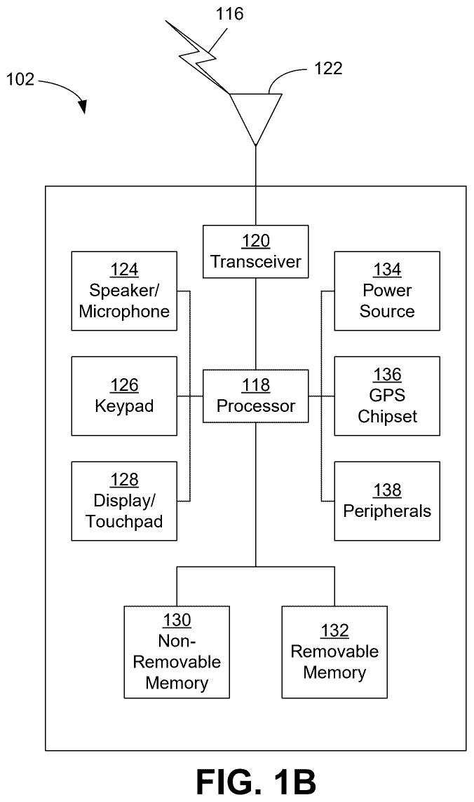

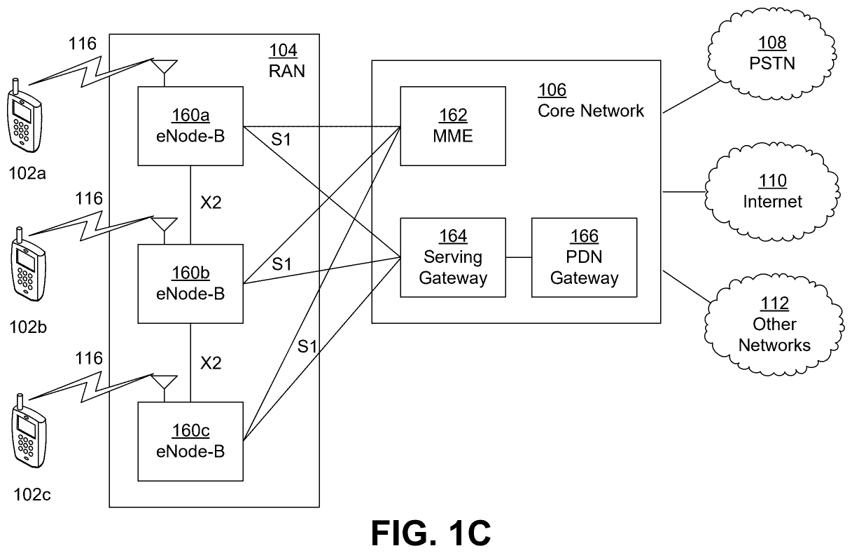

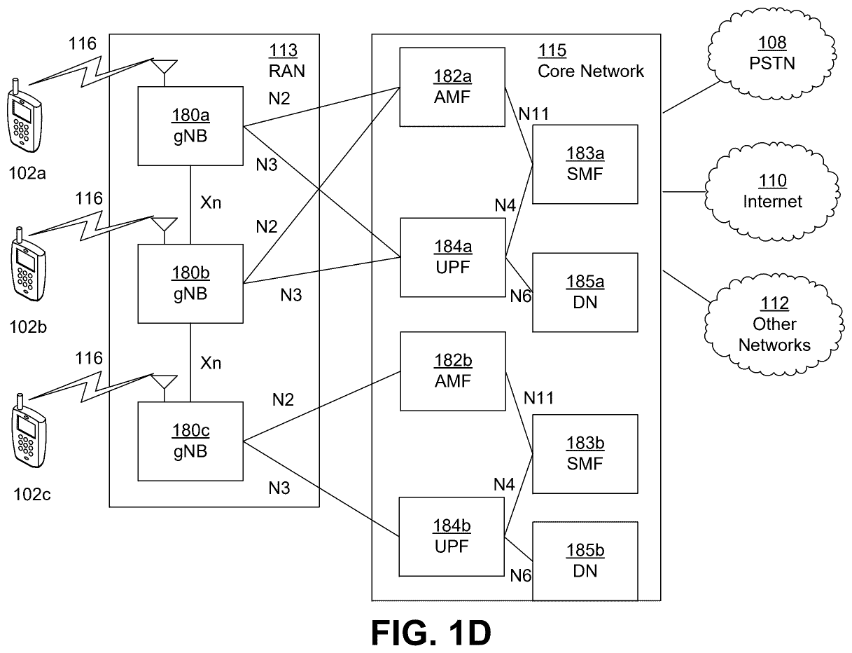

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHZ, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHZ, 2 MHZ, 4 MHZ, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 182a, 182b may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be testing equipment. Direct RF coupling and/or wireless communications via RF circuitry (e.g., which may include one or more antennas) may be used by the emulation devices to transmit and/or receive data.

Reference to a timer herein may refer to a time, a time period, a tracking of time, a tracking of a period of time, a combination thereof, and/or the like. Reference to a timer expiration herein may refer to determining that the time has occurred or that the period of time has expired.

Extended reality (XR) may be a broad umbrella term including real-and-virtual (e.g., all real-and-virtual) combined environments and human-machine interactions generated by computer technology and wearables, referring to one or more types (e.g., the following types) of immersive experiences include virtual reality (VR), augmented reality (AR), and/or mixed reality (MR).

VR may include a rendered version of a delivered visual and/or audio scene. The rendering may be designed to mimic the visual (e.g., stereoscopic 3D) and/or audio sensory stimuli of the real world as naturally as possible to an observer or user as they move within the limits defined by the application.

In an AR experience, a user may be provided with additional information or artificially generated objects/items or content overlaid upon their current environment.

MR may be a form of AR (e.g., advanced form of AR) where some virtual elements may be inserted into the physical scene with the intent to provide the illusion that the virtual elements are part of the real scene.

In examples, an immersive experience may include an interpolation of a VR, AR, and/or MR experience.

XR methods may consider multi-modality XR traffic. Multi-modality XR traffic may include input data originating from one or more devices and/or sensors (e.g., different kinds of devices and/or sensors) or the output data intended to one or more destinations (e.g., different kind of destinations such as one or more WTRUs) requested (e.g., required) for a task or application. In examples, multi-modality XR traffic may include one or more (e.g., two) service data flows, a first originating from a WTRU (e.g., a 5G WTRU such as VR glasses), and/or a second originating from a WTRU (e.g., a 5G WTRU such as haptics gloves), communicating to an application server (e.g., via the 5G network). Multi-modality XR traffic may include one or more traffic pattern characterized with at least one of payload sizes, jitters, periodicity, frame rate, data rates, and/or the like.

In examples, traffic characterization, where one or more periodicity, packet size, frames per second, jitter, data rates are given for pose/control, scene/video, and/or audio/data traffic types. For multi-modality examples, a mix of uplink (UL) and downlink (DL) transmission may be provided where a WTRU may transmit and/or receive PDU sets of N flows and M flows (e.g., where N flows may originate from a WTRU (e.g., or one or more WTRUs) and M flows may originate from associated devices to WTRUs. In multi-modality examples, the traffic pattern for multi-modality traffic may be different, and/or during transmission of traffic, the interdependency in the time domain may be preserved.

Configured grant or cell group (CG) configuration with one or more physical uplink shared channel (PUSCH) occasions may be provided. The WTRU may transmit used and/or unused CG occasions in an uplink control information (UCI) indication (UTO-UCI). An objective to facilitate efficient and effective support for a XR application with one or more quality of service (QOS) flows with multi-modal interdependencies that meet the QoS requirements and synchronization and/or coordination may provide implementation of methods that consider optimization of multiple resources (e.g. dynamic allocated resources and/or configured grants).

The WTRU may have data (e.g., new data) available for transmission that may correspond to one or more QoS parameters (e.g., QoS requirements) and/or may be associated with radio bearers (e.g., specific radio bearers such as data radio bearers (DRBs) or signaling radio bearers (SRBs)). The establishment, maintenance, and/or release of the DRBs may be radio resource control (RRC) controlled, and/or a radio bearer (e.g., each a radio bearer) may be identified by a bearer ID. The QoS parameters associated to a bearer (e.g., to each bearer) may define the level of service quality expected for the data transmission. At the UPF, the IP packets may be mapped to the QoS flows. The IP packets may be marked with a QoS flow identifier (QFI) to assist the uplink QoS handling, and the RAN may map the QoS flows to a DRB (e.g., where all data in a DRB may be handled with the same QoS treatment). The mapping of QoS flow to DRB may be executed by a SDAP and/or may be based on QFI and/or the associated QoS profiles (e.g., such that one or more QoS flows may be mapped to the same data radio bearer).

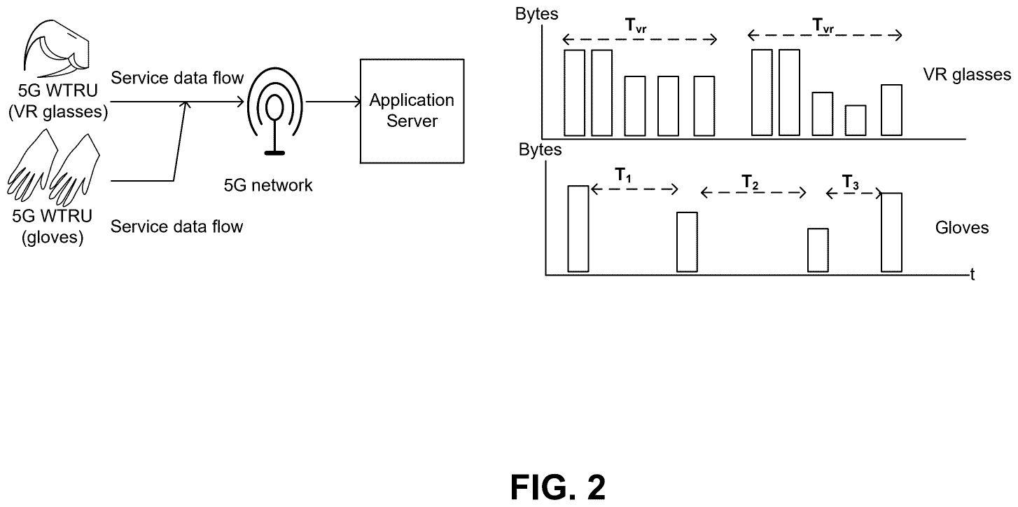

In XR, the traffic may include data and/or packet data units (PDUs). Data and/or PDUs may be associated with an application data unit (ADU), a PDU set, or a data burst. In examples, the PDUs belonging to a PDU set may be associated with one or more segments or components (e.g., different segments or components) of a video frame or a video slice. A data burst may include one or more PDU sets. In examples, a number of PDUs in a PDU set or data burst of a total payload size (e.g., units of bits/bytes) transmitted in UL and/or received in DL may be dependent on the type of the media frame (e.g., 3D video frame, audio frame, and/or the like). In examples, from the higher layers, the WTRU may receive multi-modal XR traffic as follows: input data originating from one or more devices and/or sensors (e.g., different kind of devices and/or sensors) or the output data intended to one or more destinations (e.g., different kind of destinations such as one or more WTRUs) requested (e.g., required) for a task or application (e.g., the same task or application). In examples, one or more service data flows (e.g., two service data flows) may be provided; a first originating from a WTRU (e.g., 5G WTRU such as VR glasses), whereas a second originating from a WTRU (e.g., 5G WTRU such as haptics gloves) The one or more service data flows may be communicating to an application server via the network (e.g., a 5G network). Multi-modality XR traffic may include one or more traffic patterns (e.g., different traffic patterns) characterized with one or more payload sizes (e.g., different payload sizes) (e.g., jitters, periodicity, frame rate, data rates, and/or the like). FIG. 2 shows a system with two service data flows and an illustrative traffic characterization of the flows with respect to packet size and inter-packet time intervals. In examples, PDUs of PDU sets may be associated with one or more multi-modal flows where the WTRU may map the PDUs of PDU sets to one or more LCHs.

FIG. 2 is a diagram illustrating an example of two service flows from a WTRU to an application server (e.g., left), and a representation of the two traffic patterns (e.g., right) in terms of periodicity, packet size, and/or inter-packet intervals.

Features described herein may be associated with uplink transmission of delay-sensitive multi-modal XR traffic, which may including one or more traffic patterns and/or flows. One or more features described herein may be associated with optimizing resource usage, e.g., associated with multiplexing data in transport blocks associated with different transmission characteristics (e.g., dynamically scheduled and/or semi-static and/or configured uplink resources (e.g., grants)).

The WTRU may multiplex data based on (e.g., as a function of) one or more (e.g., possibly configured) conditions. One or more conditions may be evaluated (e.g., dynamically) based on (e.g., as a function of) one or more of: a time, a data volume, data criticality (e.g., importance), and/or data priority). The WTRU may suspend a configured LCP mapping indication (e.g., an LCP mapping restriction) if a condition (e.g., one or more of the conditions) is met (e.g., satisfied). In examples, a configured LCP mapping indication (e.g., an LCP mapping restriction) may indicate that an LCH is restricted from use for transmitting PDUs of a data flow. A WTRU may suspend a LCP mapping indication (e.g., a LCP mapping restriction) based on a determination that condition(s) are satisfied, e.g., the suspension of the LCP mapping indication/restriction allows the WTRU to use the LCH that was restricted from use for transmitting PDUs of the data flow. Conditions may include a time-based condition and/or a priority-based condition. A condition may be associated with a grant characterization, a resource characterization, and/or a priority level of data.

A WTRU may perform (e.g., may be configured to perform) one or more of the following. The WTRU may receive configuration information. The WTRU may receive (e.g., from a higher layer) an indication of a data flow (e.g., DRB(s), QoS flow(s), etc.). The WTRU may determine a re-prioritization of received data (e.g., re-prioritization of received data associated with the data flow) and/or change(s) in restriction(s), such as changes/suspension of a LCH restriction. The determination may be dynamic and/or conditional and/or may be based on the specific transmission resource(s) (e.g., characteristic(s) of specific transmission resource(s). The WTRU may transmit the received data according to the determined re-prioritization and/or change(s) in restriction(s). In some examples, the WTRU may transmit an indication (e.g., a resource usage indication) that indicates selected (e.g., used) and/or unselected (e.g., unused) resource(s) (e.g., transmission occasion(s) associated with LCH(s) that are associated with the data flow(s).

Configuration information may indicate/include at least one of: one or more resources configurations (RGs); one or more LCHs; a default mapping indication (e.g., an indication of a default mapping restriction, for example a default LCP restriction); and/or a LCP mapping indication (e.g., dynamic and/or conditional), for example an indication of a LCP mapping restriction.

Received configuration information may indicate one or more resource configurations (RGs), where a resource configuration (RG) may include a resource or a group of resources (e.g., a resource group), for example, each resource configuration may include a respective resource or group of resources. In examples, an RG may include a resource parameter, e.g., each RG may include one or more respective resource parameters. Resource parameters may include one or more of: a start offset of resources, a start offset of a resource group, a number of transmission occasions (TOs) per RG period, a number of TOs per resource group, periodicities of resource(s) and/or resource group(s).

Received configuration information may indicate one or more LCHs and/or LCH parameter(s) associated with the LCH(s) (e.g., a priority, a prioritized bit rate (PBR), a buffer size duration (BSD), and/or the like.

Received configuration information may include a default mapping indication (e.g., an indication of a default mapping restriction) and/or a LCP mapping indication (e.g., an indication of a LCP mapping restriction). A LCP mapping indication may include a dynamic LCP mapping indication (e.g., restriction) and/or a conditional LCP mapping indication (e.g., restriction).

An indicated default mapping (e.g., default restriction) may include a mapping (e.g., a one-to-one mapping) between a LCH and a RG (e.g., a mapping between a first LCH and a first RG, a mapping between a second LCH and a second RG, etc.). In examples, according to the default mapping, data (e.g., all data) from a first LCH may (e.g., only) be mapped to a first RG. In examples, a default mapping indication may indicate a mapping limit (e.g., mapping of the first data may be limited to the first LCH).

A LCP mapping indication (e.g., a dynamic LCP mapping indication (e.g., LCP restriction) may indicate one or more conditions. In examples herein, based on one or more conditions of the LCP mapping indication being satisfied, the mapping indicated by the LCP mapping indication may be used (e.g., wherein in some examples using the mapping indicated by the LCP mapping indication comprises suspending or overriding a default mapping).

A LCP mapping indication (e.g., a dynamic LCP mapping indication (e.g., LCP restriction)) may indicate one or more conditions (e.g., time-based conditions and/or priority based conditions). A condition may be satisfied based on: a transmission delay (e.g., a remaining transmission delay) for first data; a priority of the first data compared to a priority for a second data; or other existing mapping restriction(s). In examples, being based on a transmission delay may include using the total transmission delay of first data (e.g., the total delay budget of the first data) or the remaining transmission delay of the first data (e.g., the remaining time left to transmit the first data with respect to the delay budget of the first data, e.g., remaining time minus time spent in the WTRU buffer).

A LCP mapping indication (e.g., a conditional LCP mapping indication (e.g., LCP restriction)) may indicate one or more conditions (e.g., time-based conditions and/or priority-based conditions). A condition (e.g., a time-based condition) may be satisfied based on a time remaining for transmission of data satisfying (e.g., being below) a (e.g., configured) threshold. A condition may be satisfied if data is in a buffer longer than (e.g., greater than) a time threshold (e.g., longer than 2 ms).

A condition may be satisfied if a remaining time with respect to a delay budget associated with data satisfies a time threshold, for example is less than a (e.g., preconfigured) threshold. In examples, a condition may be satisfied if a remaining time for transmission of the PDU satisfies a threshold within a delay budget.

A condition may be satisfied if a total time that data is in a WTRU buffer satisfies a time threshold (e.g., is greater than a threshold).

A LCP mapping indication may include a priority based-condition. A priority based condition may be whether a priority or a change in priority satisfies a threshold. The priority or change in priority may include one or more of the following: a priority or a change in priority of data, a priority or a change of a priority of a PDU in a PDU set (e.g., compared to a legacy PDU priority (e.g., a relative priority) that may come from an associated DRB), a priority of or a change in priority of a PDU set.

A priority-based condition may be whether an importance or a change in importance satisfies a threshold. The importance or change in importance may be one or more of the following: an importance of data or a change in an importance of data, an importance of a PDU or a change in importance of a PDU in a PDU set, a PSI or a change in a PSI (e.g., compared to a legacy PSI (e.g., a relative PSI)). In examples, an increase in PSI may trigger (e.g., activate) a LCP indication (e.g., prioritize the LCH with the increased PSI data if mapping data into a transport block (TB). In examples, importance of data may be based on the criticality of the data (e.g. a dynamic scorecard).

A WTRU may receive (e.g., from higher layers) one or more DRBs and/or QoS flows. In examples, a WTRU may receive PDUs of a PDU set (e.g., PDUs of respective PDU sets associated with one or more (e.g., respective) flows (e.g., multi-modal flows)). The WTRU may map the PDUs of the PDU sets to one or more LCHs (e.g., according to a mapping, such as a default mapping disclosed herein).

A WTRU may determine a re-prioritization of received data (e.g., data received from the higher layers). A WTRU may change one or more LCP mappings (e.g., LCH restriction(s) based on transmission resource(s) (e.g., used and/or unused transmission resources (TO(s) associated with a LCH) and/or condition(s) indicated in a received LCP mapping indication. In examples, a WTRU may change a LCP mapping(s) (e.g., dynamic and/or conditional LCP mapping indication(s) (e.g., LCH restriction(s))) based on the (e.g., specific) transmission resources and/or condition(s) indicated in a received LCP mapping indication.

A WTRU may determine a re-prioritization of received data and/or a change to one or more LCP mapping indications (e.g., one or more LCH mappings, restrictions, etc.) based on a remaining time to start or complete transmission of data (e.g., the received PDU(s), PDU set(s), etc.) satisfying a threshold (e.g., being less than a threshold). Start may refer to a time of reception of a dynamic grant, multiplexing in a TB, or an initial hybrid automatic repeat request (HARQ) transmission. Complete may refer to a time of HARQ ACK for TB and/or a time of an initial HARQ transmission for a (e.g., a new) TB.

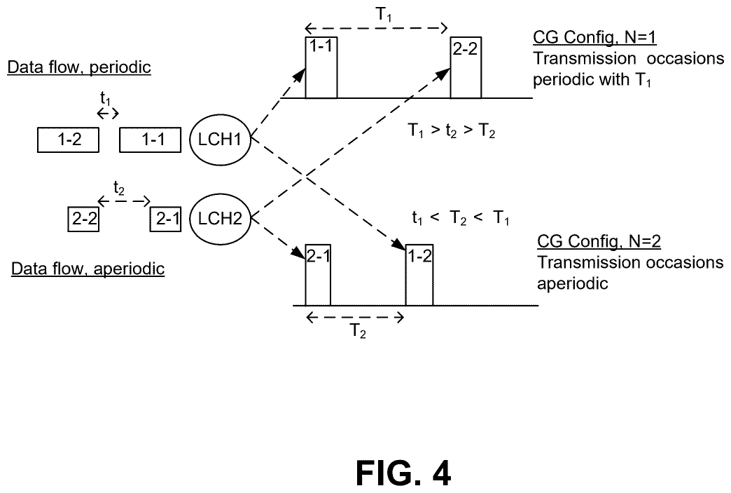

A remaining time to start and/or complete a transmission may be valid for one or more of: a PDCP SDU/PDCP PDU/RCL SDU/RLC PDU, a PDU set (e.g., at PDCP and/or any other sublayer), or an amount of data served for the corresponding PDU set. In examples, if PBR/GBR of a LCH, RB, and/or PDU set is less than a threshold (e.g., data may not be served beyond a level). In examples of re-prioritizing (e.g., remapping based on an indicated condition(s) being satisfied), the WTRU may determine to use a resource based on the following LCP mapping parameters (e.g., reprioritized/remapped LCP): use restricted RG (j) for PDU2 in LCH (i) if the time difference between arrival of PDU1 in LCH (j) and expected arrival of PDU2 in LCH (i) is within time range2. See the example of FIG. 4.

The WTRU may transmit data (e.g., the data from the higher layers) on the determined resources (e.g., remapped resources).

In some examples, the WTRU may transmit an indication (e.g., a resource usage indication) that indicates selected (e.g., used) and/or unselected (e.g., unused) resource(s) (e.g., transmission occasion(s) associated with LCH(s) and/or LCG(s) that are associated with the data flow(s). The WTRU may determine a resource for transmitting the resource usage indication. The resource used to transmit the resource usage indication may indicate information on the selected and/or unselected resources. Information may include an indication of used and/or unused transmission occasions associated with the plurality of transmission resources. A WTRU may determine and/or use a resource with an earliest TO, from a set of configured RGs, to transmit the resource usage indication. A WTRU may determine and/or use a resource from a pre-configured master and/or primary RG to transmit the resource usage indication. In some examples, the WTRU may use a grant (e.g., pre-configured grant and/or a resource granted to the WTRU following a SR, BSR, and/or DSR) that was not originally configured to indicate the resource usage indication). In examples, the resource may have been originally allocated for data transmission. The WTRU may transmit the resource usage indication and/or data (e.g., from the higher layers). The WTRU may transmit the resource usage indication in a PUCCH or PUSCH resource. The WTRU may transmit an update for the resource usage indication based on the arrival of PDUs in LCHs (e.g., based on additional and/or updated information on the arrival of PDUs in LCHs).

The term network herein may include at least one of (e.g., any of) a base station (e.g., gNB, TRP, RAN node, or access node), core network function (e.g., AMF, SMF, PCF, or NEF), and/or an application function (e.g., edge server function, or remote server function).

The term flows may correspond to at least one of (e.g., any of): QoS flows or data flows (e.g. flow of data including one or more PDUs, PDU sets or data bursts, which, in examples, may be inter-dependent with one and another and/or associated with one or more QoS parameters (e.g., QoS requirements), e.g. latency, data rate, reliability, or round-trip time (RTT) latency). Different flows (e.g., possibly originating from a common application/experience source and/or intended to a common destination WTRU or group of associated WTRs) may be referred to as associated flows or correlated flows.

The term data unit may refer to at least one of (e.g., any of): one or more frames (e.g., media, video, audio frame, and/or slice and/or segment), PDUs, PDU sets, data bursts, group of frames/PDUs/PDU-sets/data bursts. Data units may be transmitted or received by the WTRU sequentially (e.g., a first, then a second, and/or the like)) or in parallel (e.g., multiple WTRUs over different channels/links/resources, and/or the like). A data unit may be (e.g., or may not be) inter-dependent with one or more data units (e.g., each other).

The term quality of quality of experience (QoE) may include at least one of (e.g., any of): application and/or higher layer metrics and measurements, which in examples may be directly or indirectly detectable or visible at the WTRU and/or at the application function. QoE metrics and measurements may or may not be directly visible and/or detectable at the base station. QoE metrics and measurements may be determined and/or performed as a function of QoS metrics and/or parameters (e.g., latency, data rate, reliability, RTT/MTP latency, and/or the like).

In examples, processing time and/or an application consumption, and/or transmission time may be used.

In examples, processing time of XR data (e.g., PDUs, PDU sets, data bursts, and/or the like) may be associated with at least one of a compression, concatenation, segmentation, security/integrity protection, packetization, and/or multiplexing. A measurement of processing time may refer to the time it takes to process a unit of XR data from entering until leaving one or more application and/or AS layers, with a minimum and/or maximum parameter (e.g., requirement) of X seconds.

An application consumption and/or transmission time may depend on the encoding and/or decoding employed and may be WTRU specific. The time it takes for the XR application to transmit or to receive the XR data to and/or from the layers below the application layer may be a minimum and/or maximum parameter (e.g., requirement) of X seconds.

In examples, traffic parameters (e.g., requirements) and characteristics may be provided herein: A PDU Set Delay Budget (PSDB) may be the time between reception of the first PDU (e.g., at the WTRU in UL) and the successful delivery of the last arrived PDU of a PDU set (at the network in UL). A PDU Set Integrated Handling Indication (PSIHI) may indicate if/whether PDUs (e.g., all PDUs) of the PDU set are requested (e.g., needed) for the usage of PDU set by application layer. A PDU Set Error Rate (PSER) may provide an upper bound for a rate of non-congestion related PDU set losses between RAN and the WTRU. Jitter may refer to variation with respect to an expected time instance during which one or more data units may be received or transmitted. In examples, for a set of data units that may be expected to be received periodically at different periodic time instances, jitter may refer to the variation with respect to the periodic time instances (e.g., for a data unit that may be received T1 ms in advance or T2 ms later than an expected time instance at T, the jitter range may be T2 minus T1). Jitter may refer to an instantaneous value or a statistical value (e.g., an average, variance, standard deviation, max/min, and/or the like). A PSI may indicate an application and/or higher layer priority of the PDU set. A remaining time/delay may refer to the time duration remaining for receiving or transmitting one or more PDUs of a PDU set before the PSDB. A remaining time/delay may be referred to as the time to live (TTL) associated with a PDU set.

A WTRU may determine resource allocations for delay-sensitive traffic using dynamic and/or conditional LCP mapping indications (e.g., LCP mapping restrictions.

A WTRU transmitting multi-modal delay-sensitive traffic may determine (e.g., needs to flexibly determine) the resource(s) for more optimal transmission (e.g., in the case of high traffic load and/or resource scarce scenarios). The determination of a resource allocation may use dynamic and/or conditional LCP mapping indications (e.g., dynamic and/or conditional LCP mapping restrictions). In examples, a WTRU may receive a configuration information, receive data from higher layers, determine resources using a (e.g., dynamic and/or conditional) LCP mapping indication, and/or transmit the data. In some example, the WTRU may determine resource(s) to use to send a resource usage indication, and the WTRU may transmit the resource usage indication via the determined resource(s).

A WTRU may perform (e.g., may be configured to perform) one or more of the following. The WTRU may receive configuration information. The WTRU may receive (e.g., from a higher layer) an indication of a data flow (e.g., DRB(s), QoS flow(s), etc.). The WTRU may determine a re-prioritization of received data (e.g., re-prioritization of received data associated with the data flow) and/or change(s) in restriction(s), such as changes/suspension of a LCH restriction. The determination may be dynamic and/or conditional and/or may be based on the specific transmission resource(s) (e.g., characteristic(s) of specific transmission resource(s). The WTRU may transmit the received data according to the determined re-prioritization and/or change(s) in restriction(s). In some examples, the WTRU may transmit an indication (e.g., a resource usage indication) that indicates selected (e.g., used) and/or unselected (e.g., unused) resource(s) (e.g., transmission occasion(s) associated with LCH(s) that are associated with the data flow(s)).

Configuration information may indicate/include at least one of: one or more resources configurations (RGs); one or more LCHs; a default mapping indication (e.g., an indication of a default mapping restriction, for example a default LCP restriction); and/or a LCP mapping indication (e.g., dynamic and/or conditional), for example an indication of a LCP mapping restriction.

Received configuration information may indicate one or more resource configurations (RGs), where a resource configuration (RG) may include a resource or a group of resources (e.g., a resource group), for example, each resource configuration may include a respective resource or group of resources. In examples, an RG may include a resource parameter, e.g., each RG may include one or more respective resource parameters. Resource parameters may include one or more of: a start offset of resources, a start offset of a resource group, a number of transmission occasions (TOs) per RG period, a number of TOs per resource group, periodicities of resource(s) and/or resource group(s).

Received configuration information may indicate one or more LCHs and/or LCH parameter(s) associated with the LCH(s) (e.g., a priority, a prioritized bit rate (PBR), a buffer size duration (BSD), and/or the like.

Received configuration information may include a default mapping indication (e.g., an indication of a default mapping restriction) and/or a LCP mapping indication (e.g., an indication of a LCP mapping restriction). A LCP mapping indication may include a dynamic LCP mapping indication (e.g., restriction) and/or a conditional LCP mapping indication (e.g., restriction).

An indicated default mapping (e.g., default restriction) may include a mapping (e.g., a one-to-one mapping) between a LCH and a RG (e.g., a mapping between a first LCH and a first RG, a mapping between a second LCH and a second RG, etc.). In examples, according to the default mapping, data (e.g., all data) from a first LCH may (e.g., only) be mapped to a first RG. In examples, a default mapping indication may indicate a mapping limit (e.g., mapping of the first data may be limited to the first LCH).

A LCP mapping indication (e.g., a dynamic LCP mapping indication (e.g., LCP restriction)) may indicate one or more conditions. In examples herein, based on one or more conditions of the LCP mapping indication being satisfied, the mapping indicated by the LCP mapping indication may be used (e.g., wherein in some examples using the mapping indicated by the LCP mapping indication comprises suspending or overriding a default mapping).

A LCP mapping indication (e.g., a dynamic LCP mapping indication (e.g., LCP restriction) may indicate one or more conditions (e.g., time-based conditions and/or priority based conditions). A condition may be satisfied based on: a transmission delay (e.g., a remaining transmission delay) for first data; a priority of the first data compared to a priority for a second data; or other existing mapping restriction(s). In examples, being based on a transmission delay may include using the total transmission delay of first data (e.g., the total delay budget of the first data) or the remaining transmission delay of the first data (e.g., the remaining time left to transmit the first data with respect to the delay budget of the first data, e.g., remaining time minus time spent in the WTRU buffer).

A LCP mapping indication (e.g., a conditional LCP mapping indication (e.g., LCP restriction)) may indicate one or more conditions (e.g., time-based conditions and/or priority-based conditions). A condition (e.g., a time-based condition) may be satisfied based on a time remaining for transmission of data satisfying (e.g., being below) a (e.g., configured) threshold. A condition may be satisfied if data is in a buffer longer than (e.g., greater than) a time threshold (e.g., longer than 2 ms).

A condition may be satisfied if a remaining time with respect to a delay budget associated with data satisfies a time threshold, for example is less than a (e.g., preconfigured) threshold

A condition may be satisfied if a total time that data is in a WTRU buffer satisfies a time threshold (e.g., is greater than a threshold).

A LCP mapping indication may include a priority based-condition. A priority based condition may be whether a priority or a change in priority satisfies a threshold. The priority or change in priority may include one or more of the following: a priority or a change in priority of data, a priority or a change of a priority of a PDU in a PDU set (e.g., compared to a legacy PDU priority (e.g., a relative priority) that may come from an associated DRB), a priority of or a change in priority of a PDU set.

A priority-based condition may be whether an importance or a change in importance satisfies a threshold. The importance or change in importance may be one or more of the following: an importance of data or a change in an importance of data, an importance of a PDU or a change in importance of a PDU in a PDU set, a PSI or a change in a PSI (e.g., compared to a legacy PSI (e.g., a relative PSI). In examples, an increase in PSI may trigger (e.g., activate) a LCP indication (e.g., prioritize the LCH with the increased PSI data if mapping data into a TB). In examples, importance of data may be based on the criticality of the data (e.g. a dynamic scorecard).

A WTRU may receive (e.g., from higher layers) one or more DRBs and/or QoS flows. In examples, a WTRU may receive PDUs of a PDU set (e.g., PDUs of respective PDU sets associated with one or more (e.g., respective) flows (e.g., multi-modal flows)). The WTRU may map the PDUs of the PDU sets to one or more LCHs (e.g., according to a mapping, such as a default mapping disclosed herein).

A WTRU may determine a re-prioritization of received data (e.g., data received from the higher layers). A WTRU may change one or more LCP mappings (e.g., LCH restriction(s) based on transmission resource(s) (e.g., used and/or unused transmission resources (TO(s)) associated with a LCH) and/or condition(s) indicated in a received LCP mapping indication. In examples, a WTRU may change a LCP mapping(s) (e.g., dynamic and/or conditional LCP mapping indication(s) (e.g., LCH restriction(s))) based on the (e.g., specific) transmission resources and/or condition(s) indicated in a received LCP mapping indication.

A WTRU may determine a re-prioritization of received data and/or a change to one or more LCP mapping indications (e.g., one or more LCH mappings, restrictions, etc.) based on a remaining time to start or complete transmission of data (e.g., the received PDU(s), PDU set(s), etc.) satisfying a threshold (e.g., being less than a threshold). Start may refer to a time of reception of a dynamic grant, multiplexing in a TB, or an initial hybrid automatic repeat request (HARQ) transmission. Complete may refer to a time of HARQ ACK for TB and/or a time of an initial HARQ transmission for a (e.g., a new) TB.

A remaining time to start and/or complete a transmission may be valid for one or more of: a PDCP SDU/PDCP PDU/RCL SDU/RLC PDU, a PDU set (e.g., at PDCP and/or any other sublayer), or an amount of data served for the corresponding PDU set. In examples, if PBR/GBR of a LCH, RB, and/or PDU set is less than a threshold (e.g., data may not be served beyond a level). In examples of re-prioritizing (e.g., remapping based on an indicated condition(s) being satisfied), the WTRU may determine to use a resource based on the following LCP mapping parameters (e.g., reprioritized/remapped LCP): use restricted RG (j) for PDU2 in LCH (i) if the time difference between arrival of PDU1 in LCH (j) and expected arrival of PDU2 in LCH (i) is within time range2. See the example of FIG. 4.

The WTRU may transmit data (e.g., the data from the higher layers) on the determined resources (e.g., remapped resources).

In some examples, the WTRU may transmit an indication (e.g., a resource usage indication) that indicates selected (e.g., used) and/or unselected (e.g., unused) resource(s) (e.g., transmission occasion(s) associated with LCH(s) and/or LCG(s) that are associated with the data flow(s)). The WTRU may determine a resource for transmitting the resource usage indication. The resource used to transmit the resource usage indication may indicate information on the selected and/or unselected resources. Information may include an indication of used and/or unused transmission occasions associated with the plurality of transmission resources. A WTRU may determine and/or use a resource with an earliest TO, from a set of configured RGs, to transmit the resource usage indication. A WTRU may determine and/or use a resource from a pre-configured master and/or primary RG to transmit the resource usage indication. In some examples, the WTRU may use a grant (e.g., pre-configured grant and/or a resource granted to the WTRU following a SR, BSR, and/or DSR) that was not originally configured to indicate the resource usage indication). In examples, the resource may be (e.g., may have been) originally allocated for data transmission. The WTRU may transmit the resource usage indication and/or data (e.g., from the higher layers). The WTRU may transmit the resource usage indication in a PUCCH or PUSCH resource. The WTRU may transmit an update for the resource usage indication based on the arrival of PDUs in LCHs (e.g., based on additional and/or updated information on the arrival of PDUs in LCHs).

Features associated with WTRU configuration may be described herein.

The WTRU may be configured with (e.g., receive configuration information that indicates) one or more of the following: one or more RGs, one or more LCHs and/or LCH parameters, one or more LCGs, a default mapping indication, or a LCP mapping indication. The configuration information may be received via RRC signaling or other signaling.

Configuration information may indicate one or more RGs. The one or more RGs may be characterized with one or more resource parameters (e.g., each RG may be characterized with one or more respective resource parameters). In examples, the WTRU may be configured with the same resource configuration types (e.g., configured grants)). In examples, the WTRU may be configured with different resource configuration types (e.g., dynamic grant and configured grant). The grants may be classified in multiple dimensions, which may be related to the transmission occasions over time and/or related to the transmission parameters of the grants (e.g., an MCS, a number of resource elements, and/or time between HARQ retransmissions (e.g., each HARQ retransmissions)). In examples, a grant with higher MCS and a number of (e.g., a sufficient number of) resource elements may lead to less retransmission (e.g., a lower time) provided that the output TB size does not lead to segmentation that may have an impact on the transmission time. Examples of resource configurations at the WTRU side may include configured grants and/or dynamic grants (e.g., resource configurations associated with the WTRU may include configured grants and/or dynamic grants).

Configured grants may include (e.g., type 1 or type 2) one or more of: one or more PUSCH occasions (e.g., single or multiple PUSCH occasions), different resource parameters (e.g., start offset of resources), number of transmission occasions per period, or periodicity.

Dynamic grants may include one or more resource parameters (e.g., transmission occasions and/or a number of resources elements).

A resource grant (e.g., configured grant or dynamic grant), e.g., considering uplink transmissions, may indicate/include (e.g., may be configured with the following): a resource grid, resource parameter(s), and/or other parameters.

The resource grid may include one or more physical resources for WTRU transmissions (e.g., a matrix of time-frequency resource elements).

The resource parameter(s) may include at least one of a time, a frequency, a modulating and coding scheme, a resource allocation type, and/or power control.

The time may define and/or indicate when the WTRU transmission occurs (e.g., happens, is scheduled to happen, etc.) and/or may be defined in terms of starting time and/or ending time.

The frequency may define and/or indicate the frequency resources for the WTRU transmission.

The modulation and coding scheme may define and/or indicate the modulation scheme and/or coding rate for the WTRU transmission.

The resource allocation type may define or indicate if/whether the resource allocation is specific to (e.g., certain) resource blocks (e.g., localized) or spread across resource blocks (e.g., distributed).

The power control may define and/or indicate the transmit power level for the WTRU and/or ensure that signal quality is maintained.

The other parameters may be, indicate, or be related to beamforming vectors, precoding matrices, and/or antenna configurations, e.g., for the optimization of the spatial domain for transmission.

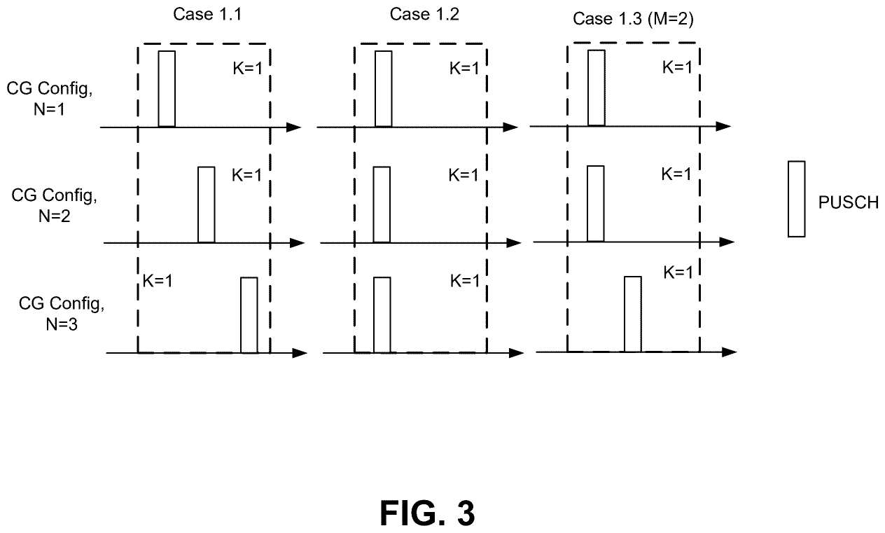

If configured with one or more resource grants (e.g., with one or more CG configurations, depending on the resource parameters relevant for each of the CGs), there may be one or more cases related to the time instance of the transmission occasions within the CGs. In examples, there may be non-overlapping (e.g., case 1.1), overlapping (e.g., case 1.2), or partially overlapping (e.g., case 1.3) transmission occasions, as depicted in FIG. 3 (e.g., N=3 CGs). In examples, the resource grants may be classified and/or differentiated by one or more (e.g., different) dimensions (e.g., not only in relation to time), such as the modulation and coding scheme (MCS), the number of resource elements, the time between HARQ retransmissions (e.g., each of the HARQ retransmissions).

FIG. 3 illustrates an example of CG configurations (e.g., three CG configurations) with one or more (e.g., three different) distributions of transmission occasions (e.g., PUSCH occasions) such as non-overlapping (e.g., case 1.1), overlapping (e.g., case 1.2), and/or partially overlapping (e.g., case 1.3).

The WTRU may receive (e.g., from the gNB) configuration information that includes/indicates at least one of (e.g., any one or more of the following): one or more LCHs including LCH parameters, one or more logical channel groups (LCGs) and their corresponding parameters, a default mapping indication, and/or a LCP mapping indication. Default mapping indication may be used interchangeably herein with default mapping restriction. LCP mapping indication may be used interchangeably herein with LCP mapping restriction.

Configuration information may include one or more LCHs including LCH parameters. A LCH (e.g., each of the LCHs) may be identified with a unique identified logical channel ID (LCID). A LCH (e.g., each LCH) may accommodate one or more (e.g., different kinds of) data transfer services (e.g., support for transfer of a particular type of information). The LCHs may be configured with one or more logical channel parameters (e.g. a priority, a prioritized bit rate (PBR), and a buffer size duration (BSD).

Relevant parameters for the LCHs may include a logical channel type, rule(s) for mapping to transport channels, or error correction.

A logical channel type may define and/or indicate the function of the LCH (e.g., a dedicated traffic channel (DTCH), a common traffic channel (CTCH), a control channel (PDCCH), and/or a signaling channel (e.g., RACH)).

Rules for mapping to transport channels may include mapping rules, multiplexing schemes, and/or allocation of resources.

Error correction may define and/or indicate mechanisms for error detection, correction, and/or retransmission (e.g., CRC, HARQ, and/or FEC).

Configuration information may include one or more LCGs and/or their corresponding parameters (e.g., the logical channels part of each LCG).

Configuration information may include a default mapping indication (e.g., default restriction) or a LCP mapping indication (e.g., a dynamic and/or conditional LCP mapping restrictions). The WTRU may share the uplink resources between the LCHs, e.g., using the RRC configured parameters configured for a channel (e.g., each of the channels) (e.g., the priority, a PBR, and/or BSD). The WTRU may serve the logical channels in one or more stages (e.g., the following stages):

In examples, (e.g., stage 1) one or more LCHs (e.g., all considered LCHs) may be served in decreasing priority order up to their configured PBR. In examples (e.g., stage 2) one or more LCHs (e.g., all considered LCHs) may be served in decreasing priority order for the remaining resources assigned by the grant.

The PBRs may be served first, and the remaining capacity may be shared between the remaining LCHs (e.g., according to their priority). In the default mapping indication (e.g., default restriction), mapping between a LCH and a RG (e.g., one-to-one mapping between a LCH and a RG) may occur (e.g., all data from a first LCH may only be mapped to a first RG according to stage 1 and stage 2). In examples of the default mapping indication, for transmission occasions from a second RG (e.g., that provide faster transfer of the data from a first LCH), the data from the first LCH may not be promoted to a higher priority (e.g., the data from the first LCH may not be mapped to transmission occasions from the second RG).

The LCP mapping indications (e.g., dynamic LCP mapping restrictions) may enable a dynamic priority of the data, and/or suspend one or more indications (e.g., suspend some restrictions) for a PDU that may have changed priority (e.g., due to time constraints, the MCS, the number of resource elements, and/or the time between HARQ retransmissions (e.g., each of the HARQ retransmissions)). LCP mapping indications may provide flexibility and adaptations regarding the mapping of data from LCHs to resource configurations. A LCP mapping indication (e.g., LCP mapping restriction) may include one or more of: a remaining transmission delay, a remaining PSDB for a PDU set, a PSIHI, or a jitter value.

An example LCP mapping indication may include a remaining transmission delay for the first data from a first LCH and the first data priority compared to the second data and/or one or more LCP mapping indications (e.g., other existing LCP mapping restrictions). In examples, if a remaining time (e.g., remaining time with respect to delay budget of the first data) and/or a remaining transmission delay for the first data is lower compared to remaining time (e.g., remaining time with respect to delay budget of the second data) and/or remaining transmission delay for the second data, and/or the first data priority is lower and/or higher compared to the second data priority, then the first data from the first LCH may be mapped to transmission occasions from different RG(s) (e.g., if an indication as described herein (e.g., including a time-based condition and/or a priority-based condition) is satisfied, then a default indication may be suspended).

An example LCP mapping indication may include a remaining PSDB for a PDU set. In examples, multiple PDU sets (e.g., two PDU sets) may be transmitted by the WTRU. Examples may include a first PDU set and a second PDU set, where the PSDB for the first PDU set may be X, whereas the PSDB for a second PDU set may be Y. If the remaining time of X passes a threshold then for data from both PDU sets, multiple RGs may be used (e.g., the default indication may be suspended based on a comparison of the PSDB of the first PDU set to the PSDB of the second PDU set, or based on a remaining time of the PSDB of the first PDU set or the remaining time for the second PDU set passing a threshold).

In examples, a LCP mapping indication may include using the PSIHI. In examples, for a first PDU set, the indication may change dynamically to indicate that one or more PDUs of the PDU set are requested by the application layer (e.g., not all PDUs of the PDU set are needed by the application layer, which may impact the WTRU to select a RG with a smaller number of transmission occasions compared to the RG that the WTRU used before the change of the indication).

In examples, a LCP mapping indication may include a using jitter values. In examples, if the jitter value for a first data is X and the jitter value for the first data changes to Y, where Y>X, the WTRU may map the first data to a first RG (e.g., that compensates for jitter X), and change the mapping of the first data to a second RG (e.g., that compensates for jitter Y) where the transmission occasions in the second RG may include variations (e.g., more variations) in their time distribution compared to the first RG.

The LCP mapping indications (e.g., conditional LCP mapping restrictions) enable dynamic priority of the data, and/or enable conditional indications (e.g., conditional restrictions) for a PDU that may have changed priority due to time constraints, the MCS, the number of resource elements, and/or the time between HARQ retransmissions (e.g., each of the HARQ retransmissions). LCP mapping indications may be based on conditions (e.g., specific conditions), and/or thresholds (e.g., time-based conditions and/or priority-based conditions and associated thresholds). In examples, a LCP mapping indication may be based on at least one of a time remaining for successful transmission of delay sensitive data, a PSDB for a PDU set, a PSIHI, or a jitter value.

A time remaining for successful transmission of delay sensitive data may satisfy a threshold (e.g., a time remaining for successful transmission of delay sensitive data may be below a configured threshold). In examples, data may be in buffer longer than a threshold of 2 ms.

A PSDB for a PDU set may satisfy a threshold (e.g., a PSDB may be below a configured threshold). In examples, a PSDB for a first PDU set may be below 10 ms.

A PSIHI may indicate that a number of PDUs from the PDU set are requested (e.g., needed) by the application layer satisfies a threshold (e.g., a number of PDUs from the PDU set are needed by the application layer is below a configured threshold).

A jitter value for a first data may satisfy a threshold (e.g., a jitter value for a first data may be below a configured threshold). In examples, a jitter value may be below a threshold of X ms.

One or more examples of thresholds that may be RRC configured and/or that may be considered in the LCP mapping indications (e.g., conditional LCP mapping restrictions) are provided: a processing time of the transmitted data may be less than X ms; a processing time of the transmitted data may be kept within an interval [Xmin, Xmax]; an application transmission time of the data may be less than X ms; an application transmission time of the data may be kept within an interval [Xmin, Xmax]; the number of unused transmission occasions may be above N; and/or the number of unused transmission occasions may be kept within an interval [Nmin, Nmax]; an initial buffering and/or rebuffering while rendering the service, and/or the user video quality metric may be below, above, and/or within predefined mean opinion score intervals; a remaining time for transmission of the PDU set may be less than X ms; a remaining time for transmission of the PDU set may be kept within an interval [Xmin, Xmax].

The RRC may control the configuration of a LCP mapping indication (e.g., LCP mapping restriction) via LCP configuration, and may add a dynamic condition (e.g., a time-based condition and/or a priority-based condition). In examples, there may be data of at least x priority available for DRB ID y or PDU set y, to at least one of: suspend the restriction for a grant (e.g., a given grant) and/or for accepting a PDU of a priority (e.g., a specific priority) in the corresponding TB (e.g., due to specific characteristics such as timing of transmission, MCS, TB size, and/or depending on whether segmentation is required).

The RCC may control the priority of a PDU associated with a DRB and/or an SRB (e.g., via DRB, SRB, and/or LCG configuration by setting up and configuring a condition for a QoS flow, a DRB, a PDU, and/or a PDU set).

The RCC may control a change in the LCP mapping indication (e.g., LCP mapping restriction) and/or the change in the priority of the PDU. The change in LCP mapping indication (e.g., LCP mapping restriction) and/or the change in the priority of the PDU may work together if/when the derived conditions from the two categories match.

The LCP mapping indication (e.g., LCP mapping restriction) and the priority of a PDU may be set by considering information from the segmentation. In examples, if there are RGs, a particular RG may be selected due to segmentation of the data. In examples, multiple (e.g., two) grants may be allocated to the WTRU where for the first grant, the WTRU may request (e.g., need) to segment the data, whereas for the second grant the WTRU may send the data (e.g., entire data) without segmentation.

The LCP mapping indications (e.g., LCP mapping restrictions) may determine the following WTRU behavior: use restricted RG (j) for PDU2 in LCH (i) if the time difference between arrival of PDU1 in LCH (j) and expected arrival of PDU2 in LCH (i) is within a configured range (e.g., range2).

Features associated with WTRU configuration may be described herein.

The WTRU may be configured with (e.g., receive configuration information that indicates) one or more of the following: one or more RGs, one or more LCHs and/or LCH parameters, one or more LCGs, a default mapping indication, or a LCP mapping indication. The configuration information may be received via RRC signaling or other signaling.

Configuration information may indicate one or more RGs. The one or more RGs may be characterized with one or more resource parameters (e.g., each RG may be characterized with one or more respective resource parameters). In examples, the WTRU may be configured with the same resource configuration types (e.g., configured grants)). In examples, the WTRU may be configured with different resource configuration types (e.g., dynamic grant and configured grant). The grants may be classified in multiple dimensions, which may be related to the transmission occasions over time and/or related to the transmission parameters of the grants (e.g., an MCS, a number of resource elements, and/or time between HARQ retransmissions (e.g., each HARQ retransmissions). In examples, a grant with higher MCS and a number of (e.g., a sufficient number of) resource elements may lead to less retransmission (e.g., a lower time) provided that the output TB size does not lead to segmentation that may have an impact on the transmission time. Examples of resource configurations at the WTRU side may include configured grants and/or dynamic grants (e.g., resource configurations associated with the WTRU may include configured grants and/or dynamic grants).

Configured grants may include (e.g., type 1 or type 2) one or more of: one or more PUSCH occasions (e.g., single or multiple PUSCH occasions), different resource parameters (e.g., start offset of resources), number of transmission occasions per period, or periodicity. Dynamic grants may include one or more resource parameters (e.g., transmission occasions and/or a number of resources elements).

A resource grant (e.g., configured grant or dynamic grant), e.g., considering uplink transmissions, may indicate/include (e.g., may be configured with the following): a resource grid, resource parameter(s), and/or other parameters.

The resource grid may include one or more physical resources for WTRU transmissions (e.g., a matrix of time-frequency resource elements).

The resource parameter(s) may include at least one of a time, a frequency, a modulating and coding scheme, a resource allocation type, and/or power control. The time may define and/or indicate when the WTRU transmission occurs (e.g., happens, is scheduled to happen, etc.) and/or may be defined in terms of starting time and/or ending time. The frequency may define and/or indicate the frequency resources for the WTRU transmission. The modulation and coding scheme may define and/or indicate the modulation scheme and/or coding rate for the WTRU transmission. The resource allocation type may define or indicate if/whether the resource allocation is specific to (e.g., certain) resource blocks (e.g., localized) or spread across resource blocks (e.g., distributed). The power control may define and/or indicate the transmit power level for the WTRU and/or ensure that signal quality is maintained.

The other parameters may be, indicate, or be related to beamforming vectors, precoding matrices, and/or antenna configurations, e.g., for the optimization of the spatial domain for transmission.

If configured with one or more resource grants (e.g., with one or more CG configurations, depending on the resource parameters relevant for each of the CGs), there may be one or more cases related to the time instance of the transmission occasions within the CGs. In examples, there may be non-overlapping (e.g., case 1.1), overlapping (e.g., case 1.2), or partially overlapping (e.g., case 1.3) transmission occasions, as depicted in FIG. 3 (e.g., N=3 CGs). In examples, the resource grants may be classified and/or differentiated by one or more (e.g., different) dimensions (e.g., not only in relation to time), such as the modulation and coding scheme (MCS), the number of resource elements, the time between HARQ retransmissions (e.g., each of the HARQ retransmissions).

FIG. 3 illustrates an example of CG configurations (e.g., three CG configurations) with one or more (e.g., three different) distributions of transmission occasions (e.g., PUSCH occasions) such as non-overlapping (e.g., case 1.1), overlapping (e.g., case 1.2), and/or partially overlapping (e.g., case 1.3).

The WTRU may receive (e.g., from the gNB) configuration information that includes/indicates at least one of (e.g., any one or more of the following): one or more LCHs including LCH parameters, one or more logical channel groups (LCGs) and their corresponding parameters, a default mapping indication, and/or a LCP mapping indication. Default mapping indication may be used interchangeably herein with default mapping restriction. LCP mapping indication may be used interchangeably herein with LCP mapping restriction.

Configuration information may include one or more LCHs including LCH parameters. A LCH (e.g., each of the LCHs) may be identified with a unique identified logical channel ID (LCID). A LCH (e.g., each LCH) may accommodate one or more (e.g., different kinds of) data transfer services (e.g., support for transfer of a particular type of information). The LCHs may be configured with one or more logical channel parameters (e.g. a priority, a prioritized bit rate (PBR), and a buffer size duration (BSD).

Relevant parameters for the LCHs may include a logical channel type, rule(s) for mapping to transport channels, or error correction. A logical channel type may define and/or indicate the function of the LCH (e.g., a dedicated traffic channel (DTCH), a common traffic channel (CTCH), a control channel (PDCCH), and/or a signaling channel (e.g., RACH)). Rules for mapping to transport channels may include mapping rules, multiplexing schemes, and/or allocation of resources. Error correction may define and/or indicate mechanisms for error detection, correction, and/or retransmission (e.g., CRC, HARQ, and/or FEC).

Configuration information may include one or more LCGs and/or their corresponding parameters (e.g., the logical channels part of each LCG).

Configuration information may include a default mapping indication (e.g., default restriction) or a LCP mapping indication (e.g., a dynamic and/or conditional LCP mapping restrictions). The WTRU may share the uplink resources between the LCHs, e.g., using the RRC configured parameters configured for a channel (e.g., each of the channels) (e.g., the priority, a PBR, and/or BSD). The WTRU may serve the logical channels in one or more stages (e.g., the following stages):

In examples, (e.g., stage 1) one or more LCHs (e.g., all considered LCHs) may be served in decreasing priority order up to their configured PBR. In examples (e.g., stage 2) one or more LCHs (e.g., all considered LCHs) may be served in decreasing priority order for the remaining resources assigned by the grant.

The PBRs may be served first, and the remaining capacity may be shared between the remaining LCHs (e.g., according to their priority). In the default mapping indication (e.g., default restriction), mapping between a LCH and a RG (e.g., one-to-one mapping between a LCH and a RG) may occur (e.g., all data from a first LCH may only be mapped to a first RG according to stage 1 and stage 2). In examples of the default mapping indication, for transmission occasions from a second RG (e.g., that provide faster transfer of the data from a first LCH), the data from the first LCH may not be promoted to a higher priority (e.g., the data from the first LCH may not be mapped to transmission occasions from the second RG).

The LCP mapping indications (e.g., dynamic LCP mapping restrictions) may enable a dynamic priority of the data, and/or suspend one or more indications (e.g., suspend some restrictions) for a PDU that may have changed priority (e.g., due to time constraints, the MCS, the number of resource elements, and/or the time between HARQ retransmissions (e.g., each of the HARQ retransmissions). LCP mapping indications may provide flexibility and adaptations regarding the mapping of data from LCHs to resource configurations. A LCP mapping indication (e.g., LCP mapping restriction) may include one or more of: a remaining transmission delay, a remaining PSDB for a PDU set, a PSIHI, or a jitter value.

An example LCP mapping indication may include a remaining transmission delay for the first data from a first LCH and the first data priority compared to the second data and/or one or more LCP mapping indications (e.g., other existing LCP mapping restrictions). In examples, if a remaining time (e.g., remaining time with respect to delay budget of the first data) and/or a remaining transmission delay for the first data is lower compared to remaining time (e.g., remaining time with respect to delay budget of the second data) and/or remaining transmission delay for the second data, and/or the first data priority is lower and/or higher compared to the second data priority, then the first data from the first LCH may be mapped to transmission occasions from different RG(s) (e.g., if an indication as described herein (e.g., including a time-based condition and/or a priority-based condition) is satisfied, then a default indication may be suspended).

An example LCP mapping indication may include a remaining PSDB for a PDU set. In examples, multiple PDU sets (e.g., two PDU sets) may be transmitted by the WTRU. Examples may include a first PDU set and a second PDU set, where the PSDB for the first PDU set may be X, whereas the PSDB for a second PDU set may be Y. If the remaining time of X passes a threshold then for data from both PDU sets, multiple RGs may be used (e.g., the default indication may be suspended based on a comparison of the PSDB of the first PDU set to the PSDB of the second PDU set, or based on a remaining time of the PSDB of the first PDU set or the remaining time for the second PDU set passing a threshold).

In examples, a LCP mapping indication may include using the PSIHI. In examples, for a first PDU set, the indication may change dynamically to indicate that one or more PDUs of the PDU set are requested by the application layer (e.g., not all PDUs of the PDU set are needed by the application layer, which may impact the WTRU to select a RG with a smaller number of transmission occasions compared to the RG that the WTRU used before the change of the indication).

In examples, a LCP mapping indication may include a using jitter values. In examples, if the jitter value for a first data is X and the jitter value for the first data changes to Y, where Y>X, the WTRU may map the first data to a first RG (e.g., that compensates for jitter X), and change the mapping of the first data to a second RG (e.g., that compensates for jitter Y) where the transmission occasions in the second RG may include variations (e.g., more variations) in their time distribution compared to the first RG.

The LCP mapping indications (e.g., conditional LCP mapping restrictions) enable dynamic priority of the data, and/or enable conditional indications (e.g., conditional restrictions) for a PDU that may have changed priority due to time constraints, the MCS, the number of resource elements, and/or the time between HARQ retransmissions (e.g., each of the HARQ retransmissions). LCP mapping indications may be based on conditions (e.g., specific conditions), and/or thresholds (e.g., time-based conditions and/or priority-based conditions and associated thresholds). In examples, a LCP mapping indication may be based on at least one of a time remaining for successful transmission of delay sensitive data, a PSDB for a PDU set, a PSIHI, or a jitter value.

A time remaining for successful transmission of delay sensitive data may satisfy a threshold (e.g., a time remaining for successful transmission of delay sensitive data may be below a configured threshold). In examples, data may be in buffer longer than a threshold of 2 ms.

A PSDB for a PDU set may satisfy a threshold (e.g., a PSDB may be below a configured threshold). In examples, a PSDB for a first PDU set may be below 10 ms.

A PSIHI may indicate that a number of PDUs from the PDU set are requested (e.g., needed) by the application layer satisfies a threshold (e.g., a number of PDUs from the PDU set are needed by the application layer is below a configured threshold).

A jitter value for a first data may satisfy a threshold (e.g., a jitter value for a first data may be below a configured threshold). In examples, a jitter value may be below a threshold of X ms.

One or more examples of thresholds that may be RRC configured and/or that may be considered in the LCP mapping indications (e.g., conditional LCP mapping restrictions) are provided: a processing time of the transmitted data may be less than X ms; a processing time of the transmitted data may be kept within an interval [Xmin, Xmax]; an application transmission time of the data may be less than X ms; an application transmission time of the data may be kept within an interval [Xmin, Xmax]; the number of unused transmission occasions may be above N; and/or the number of unused transmission occasions may be kept within an interval [Nmin, Nmax]; an initial buffering and/or rebuffering while rendering the service, and/or the user video quality metric may be below, above, and/or within predefined mean opinion score intervals; a remaining time for transmission of the PDU set may be less than X ms; a remaining time for transmission of the PDU set may be kept within an interval [Xmin, Xmax].

The RRC may control the configuration of a LCP mapping indication (e.g., LCP mapping restriction) via LCP configuration, and may add a dynamic condition (e.g., a time-based condition and/or a priority-based condition). In examples, there may be data of at least x priority available for DRB ID y or PDU set y, to at least one of: suspend the restriction for a grant (e.g., a given grant) and/or for accepting a PDU of a priority (e.g., a specific priority) in the corresponding TB (e.g., due to specific characteristics such as timing of transmission, MCS, TB size, and/or depending on whether segmentation is required).

The RCC may control the priority of a PDU associated with a DRB and/or an SRB (e.g., via DRB, SRB, and/or LCG configuration by setting up and configuring a condition for a QoS flow, a DRB, a PDU, and/or a PDU set).

The RCC may control a change in the LCP mapping indication (e.g., LCP mapping restriction) and/or the change in the priority of the PDU. The change in LCP mapping indication (e.g., LCP mapping restriction) and/or the change in the priority of the PDU may work together if/when the derived conditions from the two categories match.

The LCP mapping indication (e.g., LCP mapping restriction) and the priority of a PDU may be set by considering information from the segmentation. In examples, if there are RGs, a particular RG may be selected due to segmentation of the data. In examples, multiple (e.g., two) grants may be allocated to the WTRU where for the first grant, the WTRU may request (e.g., need) to segment the data, whereas for the second grant the WTRU may send the data (e.g., entire data) without segmentation.

The LCP mapping indications (e.g., LCP mapping restrictions) may determine the following WTRU behavior: use restricted RG (j) for PDU2 in LCH (i) if the time difference between arrival of PDU1 in LCH (j) and expected arrival of PDU2 in LCH (i) is within a configured range (e.g., range2).

Features associated with a WTRU determining transmission resource(s) are provided herein.

The WTRU may determine transmission resource(s) (e.g., dynamically) by considering one or more inputs (e.g., two inputs). A first input may be received data (e.g., data received from a higher layer as described herein). A second input may be the LCP mapping indication(s) (e.g., dynamic and/or conditional LCP mapping restrictions, as described herein). The WTRU may receive (e.g., from a higher layer) one or more DRB and/or QoS flows (e.g., comprising PDUs for transmission (e.g., PDUs that need to be transmitted) over transmission resources to be determined based on dynamic and/or conditional mapping restrictions). Trigger condition(s) (e.g., as described herein) may be dynamic and/or conditional where dynamic triggers may change over time and/or conditional triggers may be based on one or more condition(s) (e.g., certain condition(s)).

FIG. 4 illustrates an example for mapping data flows (e.g., two data flows such as periodic and/or aperiodic) to LCHs and to transmission occasions using LCP mapping indications (e.g., dynamic LCP mapping restrictions).

As illustrated in FIG. 4, there may be multiple data flows (e.g., two data flows (e.g., periodic and aperiodic) received from the higher layers and/or mapped to LCHs (e.g., two LCHs, such as LCH1 and LCH2 as illustrated). With reference to FIG. 4, two exemplary PDUs for each of the two data flows are also depicted (e.g., flow 1 is associated with PDU 1-1 and PDU 1-2, flow 2 is associated with PDU 2-1 and 2-2). The time between the PDUs in flow 1 may be denoted with t1, whereas the time between the PDUs in flow 2 may be denoted with t2. Transmission resource(s) for data flows (e.g., two data flows) may be determined (e.g., may need to be determined). The available resources may be transmission occasions from one or more CG configurations (e.g., from the two CG configurations). A first CG configuration may indicate periodic transmission occasions with period T1, and/or a second CG configuration may indicate aperiodic transmission occasions where the time interval between the transmission occasions is T2. For the transmission of PDU 1-1 from LCH1, the WTRU may determine to use the first transmission occasion from the first CG. For transmission of PDU 2-1 from LCH2, the WTRU may determine to use the first transmission occasion from the second CG. The WTRU may be configured with (e.g., via received configuration information) a LCP mapping indication (e.g., conditional LCP mapping restriction), and based on a condition in the LCP mapping indication, the WTRU may check the condition of if/whether t1 is smaller than T2 and/or if/whether T2 is smaller than T1 (e.g., T1>T2>t1). If the condition is true, the WTRU may use the second transmission occasion from CG2 for the transmission of PDU 1-2 (e.g., as shown in FIG. 4). The WTRU may (e.g., based on a condition in the LCP mapping indication) check if T1 is larger than t2 and/or if t2 is larger than T2 (e.g., T1>t2>T2). If the condition is true, the WTRU may use the second transmission occasion from CG1 for transmission of PDU 2-2.

In examples, transmission resource(s) may be dynamically determined if/when at least one of: data (e.g., new data) becomes available, a remaining time (e.g., a specific remaining time or time threshold) is reached for data that is available for transmission, and/or data has been available for transmission for at least an amount of time (e.g., a specific amount of time or threshold amount of time).

In examples, transmission resource(s) may be dynamically determined if/when data (e.g., new data) becomes available and/or a metric (e.g., a specific metric) has reached a threshold for the data that is available for transmission. In examples, the metric may include at least one of: a time remaining for successful transmission data, a processing of the data for transmission, a data rate for the transmission, a PSDB, or a jitter value for data.

A determination of transmission resource(s) for transmission of a resource usage indication may be provided.

In some examples, a determination of transmission resource(s) for transmission of a resource usage indication may be performed (e.g., based on an RRC configuration). The WTRU may determine transmission resources for transmitting resource usage indication. An UTO-UCI may be used to indicate the used and/or unused transmission occasions for a (e.g., single) CG configuration. The WTRU may determine transmission resource(s) for transmitting a resource indication (e.g., a more general resource indication) that indicates used and/or unused transmission occasions for multiple resource configurations (e.g., configured grants and/or dynamic grants).

The resource(s) for transmission of the resource usage indication may be determined (e.g., a WTRU may use a resource) based on at least one of: the WTRU may use a resource with the earliest TO from one of a set of configured RGs, the WTRU may use a resource with the latest TO from one of a set of configured RGs, the WTRU may use a resource with a TO from one of a set of configured RGs above (e.g., greater than) a predefined time instance T, the WTRU may use a resource with a TO from one of a set of configured RGs below (e.g., less than) a predefined time instance T, the WTRU may use a resource with a TO from one of a set of configured RGs where the TO falls within predefined time interval [Tmin, Tmax], or the WTRU may use a resource with a TO from a RG that is pre-determined by the NW.

In examples, the WTRU may use a TO (e.g., an additional TO) from a RG to provide an update for the resource usage indication. The condition(s) for selecting the TO (e.g., the additional TO) may be based on time or the condition(s) may be pre-determined by the NW.

WTRU transmission information may be provided herein.

The WTRU may perform transmission of (e.g., may transmit) one or more information types (e.g., two information types including a first transmission (e.g., an optional transmission) and/or a second transmission type (e.g., a mandatory transmission)).

In the first transmission (e.g., the optional transmission), the WTRU may transmit the resource usage indication (e.g., or an update to the resource usage indication). The resource usage indication (e.g., or an update to the resource usage indication) may be transmitted on determined resources as described herein. In examples, the WTRU may transmit the updated resource usage indication based on updated information (e.g., additional updated information) on the arrival of PDUs in LCH. In examples, the WTRU may transmit the updated resource usage indication based on a RG becoming available (e.g., a new RG becoming available). In examples, the resource usage indication and/or the update of the resource usage indication may be transmitted over PUCCH or PUSCH resource.

The second transmission (e.g., a mandatory transmission) may include transmission of the data (e.g., data received from a higher layer) over the determined resource(s) as described herein.

Although features and elements described herein are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

What is claimed:

1. A wireless transmit/receive unit (WTRU) comprising:
a receiver configured to:
receive configuration information that indicates a logical channel prioritization (LCP) mapping indication, wherein the LCP mapping indication includes one or more of a time-based condition or a priority-based condition;
receive an indication of a data flow, wherein the data flow is mapped to a first logical channel, and wherein a protocol data unit (PDU) is associated with the data flow;
a processor configured to:
determine a transmission resource to use for transmission of the PDU, wherein the determination of the transmission resource is based on a condition, of the one or more conditions indicated in the configuration information, being satisfied, and wherein the determined transmission resource is associated with a second logical channel; and
a transmitter configured to:
transmit the PDU via the determined transmission resource that is associated with the second logical channel.

2. The WTRU of claim 1, wherein the satisfied condition is the time-based condition, and wherein the time-based condition comprises at least one of: a time remaining for transmission of the PDU satisfies a threshold within a delay budget, a time that the PDU has been in a buffer satisfies a threshold, or a transmission delay associated with transmission of the PDU is within the delay budget.

3. The WTRU of claim 1, wherein the satisfied condition is the priority-based condition, and wherein the priority-based condition comprises at least one of: a priority, a relative priority, a change in priority associated with the PDU satisfies a first threshold, a PDU set importance (PSI), a relative PSI, or a change in PSI associated with the PDU satisfies a second threshold.

4. The WTRU of claim 1, wherein:
the receiver is further configured to:
receive an indication of a plurality of transmission resources, wherein the plurality of transmission resources comprises the transmission resource;
the processor is further configured to:
determine a resource usage indication, wherein the resource usage indication indicates one or more used or unused transmission occasions associated with the plurality of transmission resources; and
determine a resource usage indication resource; and
the transmitter is further configured to:
transmit the resource usage indication on the resource usage indication resource.

5. The WTRU of claim 1, wherein the processor is further configured to receive an indication of a default mapping that indicates a mapping limit, and wherein the mapping limit limits mapping of the data flow to the first logical channel.

6. The WTRU of claim 5, wherein the mapping limit is suspended based on the determination that the transmission resource that is associated with the second logical channel satisfies the condition.

7. The WTRU of claim 1, wherein the processor is further configured to determine that the condition is satisfied based on a transmission occasion associated with the first logical channel and a transmission occasion associated with the second logical channel, and wherein the determined transmission resource is associated with the transmission occasion associated with the second logical channel.

8. A method comprising:
receiving configuration information that indicates a logical channel prioritization (LCP) mapping indication, wherein the LCP mapping indication includes one or more of a time-based condition or a priority-based condition;
receiving an indication of a data flow, wherein the data flow is mapped to a first logical channel, and wherein a protocol data unit (PDU) is associated with the data flow;
determining a transmission resource to use for transmission of the PDU, wherein the determination of the transmission resource is based on a condition, of the one or more conditions indicated in the configuration information, being satisfied, and wherein the determined transmission resource is associated with a second logical channel; and
transmitting the PDU via the determined transmission resource that is associated with the second logical channel.

9. The method of claim 8, wherein the satisfied condition is the time-based condition, and wherein the time-based condition comprises at least one of: a time remaining for transmission of the PDU satisfies a threshold within a delay budget, a time that the PDU has been in a buffer satisfies a threshold, or a transmission delay associated with transmission of the PDU is within the delay budget.

10. The method of claim 8, wherein the satisfied condition is the priority-based condition, and wherein the priority-based condition comprises at least one of: a priority, a relative priority, a change in priority associated with the PDU satisfies a first threshold, a PDU set importance (PSI), a relative PSI, or a change in PSI associated with the PDU satisfies a second threshold.

11. The method of claim 8, wherein the method further comprises:
receiving an indication of a plurality of transmission resources, wherein the plurality of transmission resources comprises the transmission resource;
determining a resource usage indication, wherein the resource usage indication indicates one or more used or unused transmission occasions associated with the plurality of transmission resources;
determining a resource usage indication resource; and
transmitting the resource usage indication on the resource usage indication resource.

12. The method of claim 8, wherein the method further comprises:
receiving an indication of a default mapping that indicates a mapping limit, and wherein the mapping limit limits mapping of the data flow to the first logical channel.

13. The method of claim 12, wherein the mapping limit is suspended based on the determination that the transmission resource that is associated with the second logical channel satisfies the condition.

14. The method of claim 8, wherein the method further comprises:
determining that the condition is satisfied based on a transmission occasion associated with the first logical channel and a transmission occasion associated with the second logical channel, and wherein the determined transmission resource is associated with the transmission occasion associated with the second logical channel.
